(19) United States
(12) Patent Application Publication
(10) Pub. No.: US 2007/0019883 A1
(43) Pub. Date: Jan. 25, 2007

(54) Method for creating a depth map for auto focus using an all-in-focus picture and two-dimensional scale space matching

(76) Inventors: Earl Quong Wong, Vallejo, CA (US); Makibi Nakamura, Tokyo (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/185,611

(22) Filed: Jul. 19, 2005

(51) Int. Cl. G06K 9/36; G06K 9/00

(52) U.S. Cl. 382/276; 382/154

(57) ABSTRACT

An imaging acquisition system that generates a depth map for a picture of a three dimension spatial scene from the estimated blur radius of the picture is described. The system generates an all-in-focus reference picture of the three dimension spatial scene. The system uses the all-in-focus reference picture to generate a two-dimensional scale space representation. The system computes the picture depth map for a finite depth of field using the two-dimensional scale space representation.

### RELATED APPLICATIONS

This patent application is related to the co-pending U.S. patent application, entitled DEPTH INFORMATION FOR AUTO FOCUS USING TWO PICTURES AND TWO-DIMENSIONAL GAUSSIAN SCALE SPACE THEORY, Ser. No. ______.

### FIELD OF THE INVENTION

This invention relates generally to imaging, and more particularly to generating a depth map from multiple images.

### COPYRIGHT NOTICE/PERMISSION

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright © 2004, Sony Electronics, Incorporated, All Rights Reserved.

### BACKGROUND OF THE INVENTION

A depth map is a map of the distance from objects contained in a three dimensional spatial scene to a camera lens acquiring an image of the spatial scene. Determining the distance between objects in a three dimensional spatial scene is an important problem in, but not limited to, auto-focusing digital and video cameras, computer/robotic vision and surveillance.

There are typically two types of methods for determining a depth map: active and passive. An active system controls the illumination of target objects, whereas a passive system depend on the ambient illumination. Passive systems typically use either (i) shape analysis, (ii) multiple view (e.g. stereo) analysis or (iii) depth of field/optical analysis. Depth of field analysis cameras rely of the fact that depth information is obtained from focal gradients. At each focal setting of a camera lens, some objects of the spatial scene are in focus and some are not. Changing the focal setting brings some objects into focus while taking other objects out of focus, i.e. blurring the objects in the scene. The change in focus for the objects of the scene at different focal points is a focal gradient. A limited depth of field inherent in most camera systems causes the focal gradient.

In one embodiment, measuring the focal gradient to compute a depth map determines the depth from a point in the scene to the camera lens as follows:

$${d}_{o} = \frac{fD}{D - f - 2 {rf}_{number}} \qquad ( 1 )$$

where f is the camera lens focal length, D the distance between the image plane inside the camera and the lens, r is the blur radius of the image on the image plane and f_{number} is the f_{number} of the camera lens. The f_{number} is equal to the camera lens focal length divided by the lens aperture. Except for the blur radius, all the parameters on the right hand side of Equation 1 are known when the image is captured. Thus, the distance from the point in the scene to the camera lens is calculated by estimating the blur radius of the point in the image.

Capturing two images of the same scene using different apertures for each image is a way to calculate the change in blur radius. Changing aperture between the two images causes the focal gradient. The blur radius for a point in the scene is calculated by calculating the Fourier transforms of the matching image portions and assuming the blur radius is zero for one of the captured images.

### SUMMARY OF THE INVENTION

An imaging acquisition system that generates a depth map for a picture of a three dimension spatial scene from the estimated blur radius of the picture is described. The system generates an all-in-focus reference picture of the three dimension spatial scene. The system uses the all-in-focus reference picture to generate a two-dimensional scale space representation. The system computes the picture depth map for a finite depth of field using the two-dimensional scale space representation.

The present invention is described in conjunction with systems, clients, servers, methods, and machine-readable media of varying scope. In addition to the aspects of the present invention described in this summary, further aspects of the invention will become apparent by reference to the drawings and by reading the detailed description that follows.

### BRIEF DESCRIPTION OF THE DRAWINGS

The present invention is illustrated by way of example and not limitation in the figures of the accompanying drawings in which like references indicate similar elements.

FIG. 1A illustrates one embodiment of an imaging system.

FIG. 1B illustrates one embodiment of an imaging optics model.

FIG. 2 is a flow diagram of one embodiment of a method to generate a depth map.

FIG. 3 is a flow diagram of one embodiment of a method to generate an all-in-focus reference picture.

FIG. 4 illustrates one embodiment of a sequence of reference images used to generate an all-in-focus reference picture.

FIG. 5 illustrates one embodiment of selecting a block for the all-in-focus reference picture.

FIG. 6 illustrates one embodiment of generating a two-dimensional (2D) scale space representation of the all-in-focus reference picture using a family of convolving kernels.

FIG. 7 illustrates an example of creating the all-in-focus reference picture 2D scale space representation.

FIG. 8 is a flow diagram of one embodiment of a method that generates a picture scale map.

FIG. 9 illustrates one embodiment of selecting the blur value associated with each picture block.

FIG. 10 illustrates one embodiment of using the scale space representation to find a block for the picture scale map.

FIG. 11 illustrates one embodiment of calculating the depth map from the picture scale map.

FIG. 12 is a block diagram illustrating one embodiment of an image device control unit that calculates a depth map.

FIG. 13 is a diagram of one embodiment of an operating environment suitable for practicing the present invention.

FIG. 14 a diagram of one embodiment of a computer system suitable for use in the operating environment of FIG. 2.

### DETAILED DESCRIPTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. The following detailed description is, therefore, not to be taken in a limiting sense, and the scope of the present invention is defined only by the appended claims.

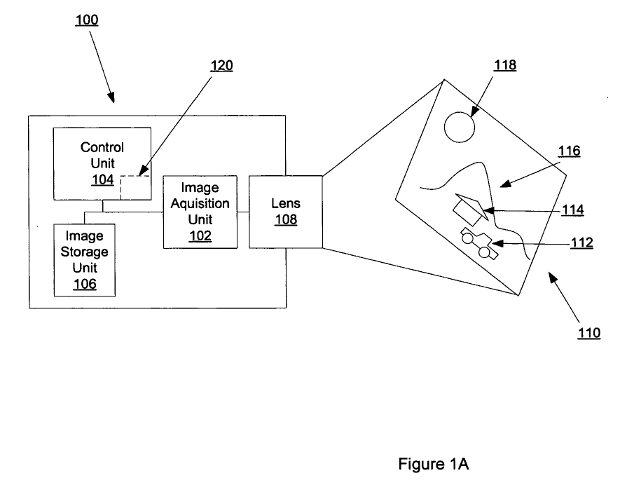

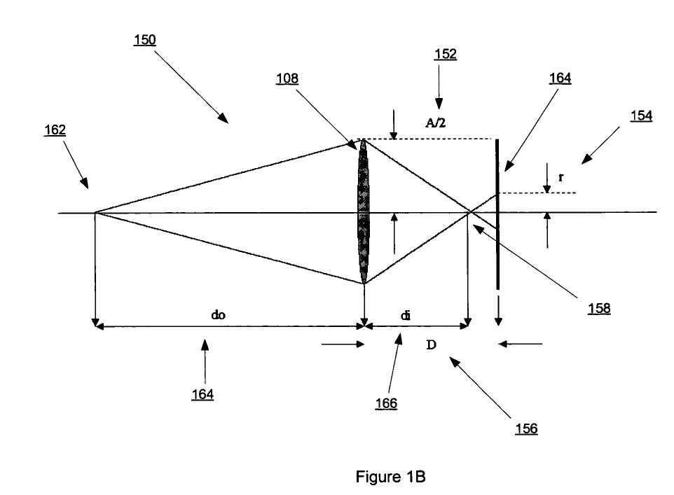

FIG. 1A illustrates one embodiment of an imaging system 100 that captures an image of a three dimensional spatial scene 110. References to an image or a picture refer to an image of a three dimensional scene captured by imaging system 100. Imaging system 100 comprises an image acquisition unit 102, a control unit 104, an image storage unit 106, and lens 108. Imaging system 100 may be, but not limited to, digital or film still camera, video camera, surveillance camera, robotic vision sensor, image sensor, etc. Image acquisition unit 102 captures an image of scene 110 through lens 108. Image acquisition unit 102 can acquire a still picture, such as in a digital or film still camera, or acquire a continuous picture, such as a video or surveillance camera. Control unit 104 typically manages the image acquisition unit 102 and lens 108 automatically and/or by operator input. Control unit 104 configures operating parameters of the image acquisition unit 102 and lens 108 such as, but not limited to, the lens focal length, f, the aperture of the lens, A, the lens focus focal length, and (in still cameras) the shutter speed. In addition, control unit 104 may incorporate a depth map unit 120 (shown in phantom) that generates a depth map of the scene. The image(s) acquired by image acquisition unit 102 are stored in the image storage 106.

In FIG. 1A, imaging system 100, records an image of scene 110. While in one embodiment scene 110 is composed of four objects: a car 112, a house 114, a mountain backdrop 116 and a sun 118, other embodiments of scene 110 may be composed of several hundred objects with very subtle features. As is typical in most three dimensional scenes recorded by the lens of the imaging system 100, objects 112-118 in scene 110 are at different distances to lens 108. For example, in scene 110, car 112 is closest to lens 108, followed by house 114, mountain backdrop 116 and sun 118. Because of the limited depth of field inherent in lens 108, a focal setting of lens 108 will typically have some objects of scene 110 in focus while others will be out of focus. Although references to objects in an image, portions of an image or image block do not necessarily reflect the same specific subdivision of an image, these concepts all refer to a type of image subdivision.

FIG. 1B illustrates one embodiment of an imaging optics model 150 used to represent lens 108. The optics model 150 represents lens 108 focusing on the point image 162 resulting in an image 158 displayed on the image plane. Lens 108 has aperture A. The radius of the aperture (also known as the lens radius) is shown in 152 as A/2. By focusing lens 108 on point image 162, image 158 is displayed on image plane 164 as a point as well. On the other hand, if lens 108 is not properly focused on the point image 162, image 158 is displayed on the image plane 164 as a blurred image 154 with a blur radius r. Distance dᵢ 166 is the distance between image 158 and lens 108 and distance dₒ 164 is the distance between point 162 and lens 108. Finally, D is the distance between lens 108 and image plane 164.

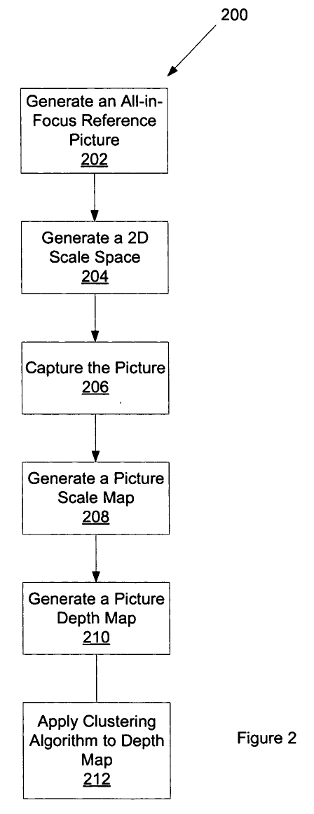

FIGS. 2, 3 and 8 illustrate embodiments of methods performed by imaging acquisition unit 100 of FIG. 1A to calculate a depth map from an estimated blur radius. In one embodiment, Equation 1 is used to calculate the depth map from the estimated blur radius. In addition, FIGS. 2, 3, and 8 illustrate estimating a blur radius by building an all-in-focus reference picture, generating a 2D scale space representation of the reference picture and matching the focal details of a finite depth of field image to the 2D scale space representation. The all-in-focus reference picture is a representation of the actual image that has every portion of the image in focus. Minor exceptions will occur at locations containing significant depth transitions. For example and by way of illustration, if there are two objects in a scene—a foreground object and a background object—the all in focus picture will contain a non-blurred picture of the foreground object and a non-blurred picture of the background object. However, the all in focus image may not be sharp in a small neighborhood associated with the transition between the foreground object and the background object. The 2D scale space representation is a sequence of uniformly blurred pictures of the all-in-focus reference picture, with each picture in the sequence progressively blurrier than the previous picture. Furthermore, each picture in the 2D scale space sequence represents a known blur radius. Matching each portion of the actual image with the appropriate portion of the scale space representation allows deviation of the blur radius that image portion.

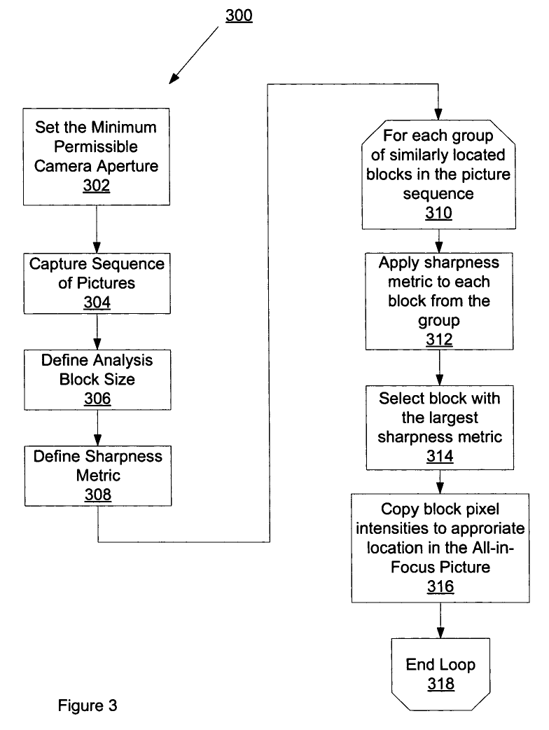

FIG. 2 is a flow diagram of one embodiment of a method 200 to generate a depth map of scene 110. At block 202, method 200 generates an all-in-focus reference picture of scene 110. All the objects of scene 110 are in focus in the all-in-focus reference picture. Because of the limited depth of field of most camera lens, multiple pictures of scene 110 are used to generate the all-in-focus reference picture. Thus, the all-in-focus reference picture represents a picture of scene 110 taken with an unlimited depth of field lens. Generation of the all-in-focus reference picture is further described FIG. 3.

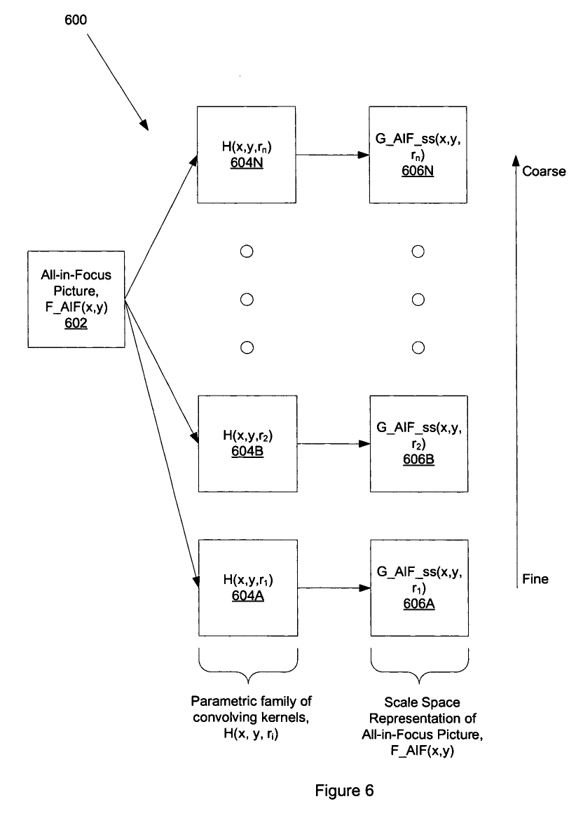

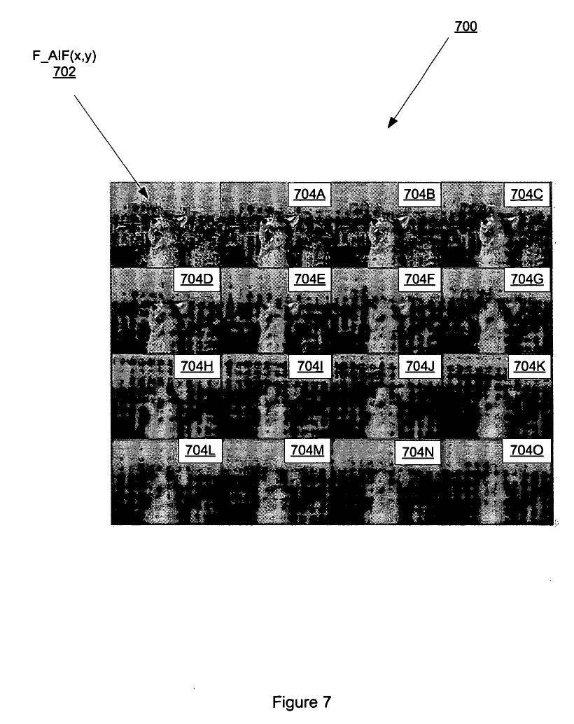

At block 204, method 200 generates a 2D scale space of the all-in-focus reference picture by applying a parametric family of convolving kernels to the all-in-focus reference picture. The parametric family of convolving kernels applies varying amounts of blur to the reference picture. Each kernel applies a known amount of blur to each object in scene 110, such that each portion of the resulting picture is equally blurred. Thus, the resulting 2D scale space is a sequence of quantifiably blurred pictures; each subsequent picture in the sequence is a progressively blurrier representation of the all-in-focus reference picture. Because the blur applied by each convolving kernel is related to a distance, the 2D scale space representation determines picture object depths. The 2D scale space representation is further described in FIGS. 6 and 7.

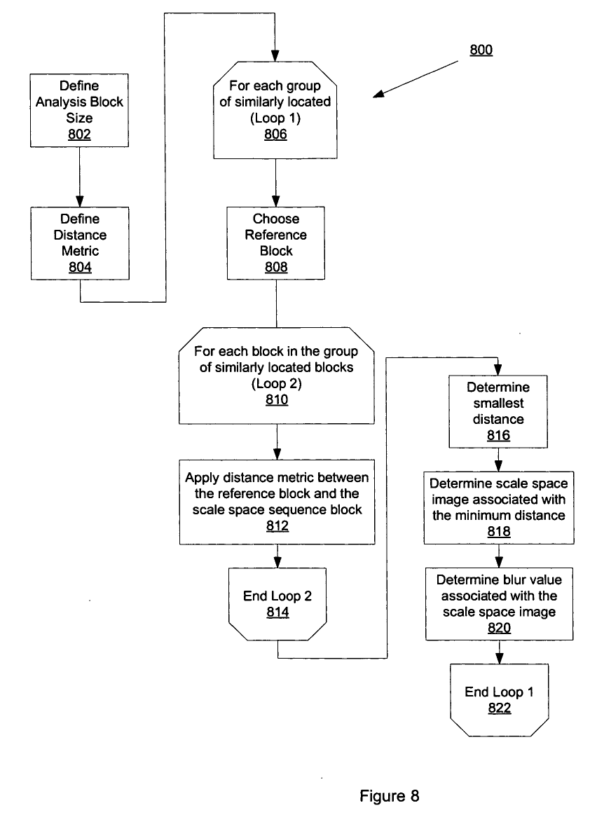

At block 206, method 200 captures a finite depth of field picture of scene 110. In one embodiment, method 200 uses one of the pictures from the all-in-focus reference picture generation at block 202. In an alternate embodiment, method 200 captures a new picture of scene 110. However, in the alternate embodiment, the new picture should be a picture of the same scene 110 with the same operating parameters as the pictures captured for the all-in-focus reference picture. At block 208, method 200 uses the picture captured in block 206 along with the 2D scale space to generate a picture scale map. Method 200 generates the picture scale map by determining the section of the finite depth of field picture that best compares with a relevant section from the 2D scale space. Method 200 copies the blur value from the matching 2D scale space into the picture scale map. Generation of the picture scale map is further described in FIGS. 8-10.

At block 210, method 200 generates a picture depth map from the picture scale map using the geometric optics model. As explained above, the geometric optics model relates the distance of an object in a picture to a blurring of that object. Method 200 calculates a distance from the associated blur value contained in the picture scale map using Equation 1. Because the lens focal length, f, distance between the camera lens 108 and image plane 164, D, and f_{number} are constant at the time of acquiring the finite depth of field picture, method 200 computes the distance value of the depth map from the associated blur radius stored in the picture scale map.

At block 212, method applies a clustering algorithm to the depth map. The clustering algorithm is used to extract regions containing similar depths and to isolate regions corresponding to outliers and singularities. Clustering algorithms are well-known in the art. For example, in one embodiment, method 200 applies nearest neighbor clustering to the picture depth map.

FIG. 3 is a flow diagram of one embodiment of a method 300 that generates an all-in-focus reference picture. As mentioned above, all objects contained in the all-in-focus reference picture are in focus. This is in contrast to a typical finite depth of field picture where some of the objects are in focus and some are not, as illustrated in FIG. 1A above. Method 300 generates this reference picture from a sequence of finite depth of field pictures. The all-in-focus reference picture is further used as a basis for the 2D scale space representation.

At block 302, method 300 sets the minimum permissible camera aperture. In one embodiment, method 300 automatically selects the minimum permissible camera operation. In another embodiment, the camera operator sets the minimum camera operative. At block 304, method 300 causes the camera to capture a sequence of pictures that are used to generate the all-in-focus reference picture. In one embodiment, the sequence of pictures differs only in the focal point of each picture. By setting the minimum permissible aperture, each captured image contains a maximum depth range that is in focus. For example, referring to scene 110 in FIG. 1A, a given captured image with a close focal point may only have car 112 in focus. The subsequent picture in the sequence has different objects in focus, such as house 114, but not car 112. A picture with a far focal point has mountain backdrop 116 and sun 118 in focus, but not car 112 and house 114. For a given captured picture, each preceding and succeeding captured picture in the sequence has an adjacent, but non-overlapping depth range of scene objects in focus. Thus, there are a minimal number of captured pictures that is required to cover the entire focal range of objects contained in scene 110. The number of captured pictures needed for an all-in-focus reference picture depends on scene itself and external conditions of the scene. For example and by way of illustration, the number of images required for an all-in-focus reference picture of a scene on a bright sunny day using a smaller aperture is typically a smaller number than for the same scene on a cloudy day using a larger aperture. Pictures of a scene using a small aperture have a large depth of field. Consequently, fewer pictures are required for the all-in-focus reference picture. In contrast, using a large aperture for a low light scene gives a smaller depth of field. Thus, with a low-light, more pictures are required for the all-in-focus reference picture. For example and by way of illustration, a sunny day scene may require only two small aperture pictures for the all-in-focus reference picture, while a cloudy day scene would require four large aperture pictures.

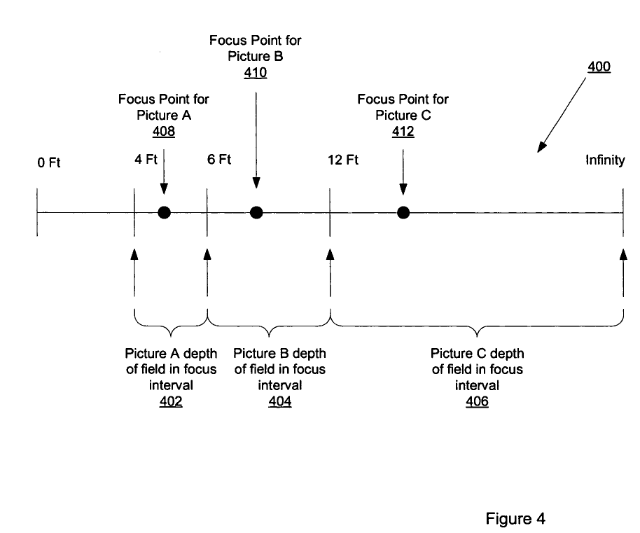

FIG. 4 illustrates one embodiment of a sequence of captured pictures used to generate an all-in-focus reference picture. In FIG. 4, three captured pictures 408-412 are taken at different focal points. Each picture represents a different depth of field focus interval. For example, for picture A 408, the depth of field focus interval 402 is from four to six feet. Thus, in picture A, focused objects in scene 110 are further than four feet from lens 108 but closer than six feet. All other picture objects not within this distance range are out of focus. By way of example and referring to FIG. 1A, objects of scene 110 in focus for this depth of field interval is car 112, but not house 114, mountain backdrop 116 or sun 118. Similarly, in FIG. 4, picture B's depth of field focus interval 404 is between six and twelve feet. Finally, picture C's depth of field focus interval 404 is greater than twelve feet. As another example and by way of referring to FIG. 1A, mountain backdrop 116 and sun 118 are in focus for picture C, but not car 112 or house 114. Therefore, the group of captured pictures 408-412 can be used for the all-in-focus reference picture if the objects in scene 110 are in focus in at least one of captured pictures 408-412.

Returning to FIG. 3, at block 306, method 300 selects an analysis block size. In one embodiment, the analysis block size is square block of k×k pixels. While in one embodiment, a block size of 16×16 or 32×32 pixels is used; alternative embodiments may use a smaller or larger block size. The choice of block size should be small enough to sufficiently distinguish the different picture objects in the captured picture. Furthermore, each block should represent one depth level or level of blurring. However, the block should be large enough to be able to represent picture detail, i.e., show the difference between a sharp and blurred images contained in the block. Alternatively, other shapes and sizes can be used for analysis block size (e.g., rectangular blocks, blocks within objects defined by image edges, etc.).

At block 308, method 300 defines a sharpness metric. Method 300 uses the sharpness metric to select the sharpest picture block, i.e., the picture block most in focus. In one embodiment, the sharpness metric corresponds to computing the variance of the pixel intensities contained in the picture block and selecting the block yielding the largest variance For a given picture or scene, a sharp picture has a wider variance in pixel intensities than a blurred picture because the sharp picture has strong contrast of intensity giving high pixel intensity variance. On the other hand a blurred picture has intensities that are washed together with weaker contrasts, resulting in a low pixel intensity variance. Alternative embodiments use different sharpness metrics well known in the art such as, but not limited to, computing the two dimensional FFT of the data and choosing the block with the maximum high frequency energy in the power spectrum, applying the Tenengrad metric, applying the SMD (sum modulus difference), etc.

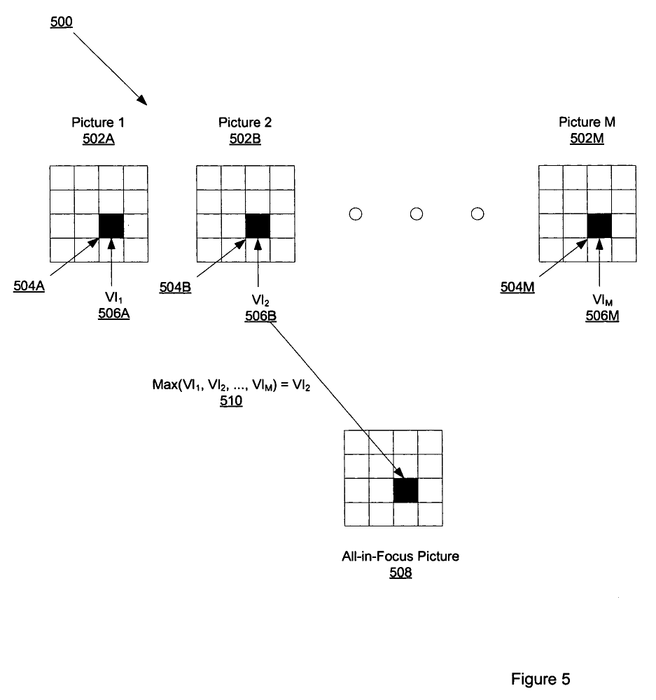

Method 300 further executes a processing loop (blocks 310-318) to determine the sharpest block from the each block group of the captured pictures 408-412. A block group is a group of similarly located blocks within the sequence of captured pictures 408-412. FIG. 5 illustrates one embodiment of selecting a block from a block group based on the sharpness metric. Furthermore, FIG. 5 illustrates the concept of a block group, where each picture in a sequence of captured pictures 502A-M is subdivided into picture blocks. Selecting a group of similarly located blocks 504A-M gives a block group.

Returning to FIG. 3, method 300 executes a processing loop (blocks 310-318) that processes each unique block group. At block 312, method 300 applies the sharpness metric to each block in the block group. Method 300 selects the block from the block group that has the largest metric at block 314. This block represents the block from the block group that is the sharpest block, or equivalently, the block that is most in focus. At block 316, method 300 copies the block pixel intensities corresponding to the block with the largest block sharpness metric into the appropriate location of the all-in-focus reference picture.

The processing performed by blocks 310-318 is graphically illustrated in FIG. 5. In FIG. 5, each block 504A-M has a corresponding sharpness value VI_{I}-VI_{M} 506A-M. In this example, block 502B has the largest sharpness value, VI₂ 506B. Thus, the pixel intensities of block 502B are copied into the appropriate location of the all-in-focus reference picture 508.

FIG. 6 illustrates one embodiment of generating a 2D scale space representation of the all-in-focus reference picture using a family of convolving kernels as performed by method 200 at block 204. Specifically, FIG. 6 illustrates method 200 applying a parametric family of convolving kernels (H(x, y, rᵢ), i=1, 2, . . . n) 604A-N is applied to the all-in-focus reference picture F_AIF(x,y) 602 as follows:
G_{—}AIF_{—}ss(x,y,rᵢ)=F_{—}AIF(x,y)*H(x,y,rᵢ) (2)
The resulting picture sequence, G_AIF_ss(x, y, rᵢ) 606A-N, represents a progressive blurring of the all-in-focus reference picture, F_AIF(x, y). As i increases, the convolving kernel applies a stronger blur to the all-in-focus reference picture and thus giving a blurrier picture. The blurred pictures sequence 606A-N is the 2D scale space representation of F_AIF(x,y). Examples of convolving kernel families are well known in the art and are, but not limited to, gaussian or pillbox families. If using a gaussian convolving kernel family, the conversion from blur radius to depth map by Equation 1 changes by substituting r with kr, where k is a scale factor converting gaussian blur to pillbox blur.

FIG. 7 illustrates an example of creating the all-in-focus reference picture 2D scale space representation. In FIG. 7, sixteen pictures are illustrated: the all-in-focus reference picture F_AIF(x,y) 702 and fifteen pictures 704A-O representing the 2D scale space representation. As discussed above, all the objects contained in F_AIF(x,y) 702 are in focus. Pictures 704A-O represent a quantitatively increased blur applied to F_AIF(x,y) 702. For example, pictures 704A represents little blur compared with F_AIF(x,y) 702. However, picture 704D shows increased blur relative to 704A in both the main subject and the picture background. Progression across the 2D scale space demonstrates increased blurring of the image resulting in an extremely blurred image in picture 704O.

FIG. 8 is a flow diagram of one embodiment of a method 800 that generates a picture scale map. In FIG. 8, at block 802, method 800 defines a block size for data analysis. In one embodiment, the analysis block size is square block of s×s pixels. While in one embodiment, a block size of 16×16 or 32×32 pixels is used; alternative embodiments may use a smaller or larger block size. The choice of block size should be small enough to sufficiently distinguish the different picture objects in the captured picture. Furthermore, each block should represent one depth level or level of blurring. However, the block should be large enough to be able to represent picture detail (i.e. show the different between a sharp and blurred image within contained in the block). Alternatively, other shapes and sizes can be used for analysis block size (e.g., rectangular blocks, blocks within objects defined by image edges, etc.). The choice in block size also determines the size of the scale and depth maps. For example, if the block size choice results in N blocks, the scale and depth maps will have N values.

At block 804, method 800 defines a distance metric between similar picture blocks selected from the full depth of field picture and a 2D scale space picture. In one embodiment, the distance metric is:

$$Dist = {\sum }_{i , = x , j = y}^{i = x + s - 1 , j = y + s - 1} \vert F\_FDF ( i , j ) - G\_AIF \_ss ( i , j , {r}_{1} ) \vert \qquad ( 3 )$$

where F_FDF(i,j) and G_AIF ss(i,j,rᵢ) are the pixel intensities of pictures F_FDF and G_AIF_ss, respectively, at pixel i,j and l=1, 2, . . . , M (with M being the number of pictures in the 2D scale space). The distance metric measures the difference between the picture block of the actual picture taken (i.e. the full depth of field picture) and a similarly located picture block from one of the 2D scale space pictures. Alternatively, other metrics known in the art measuring image differences could be used as a distance metric (e.g., instead of the 1 norm shown above, the 2 norm (squared error norm), or more generally, the p norm for p>=1 can be used, etc.) Method 800 further executes two processing loops. The first loop (blocks 806-822) selects the blur value associated with each picture block of the finite depth of field picture. At block 808, method 800 chooses a reference picture block from the finite depth of field picture. Method 800 executes a second loop (blocks 810-814) that calculates a set of distance metrics between the reference block and each of the similarly located blocks from the 2D scale space representation. At block 816, method 800 selects the smallest distance metric from the set of distance metrics calculated in the second loop. The smallest distance metric represents the closest match between the reference block and a similarly located block from a 2D scale space picture.

At block 818, method 800 determines the scale space image associated with the minimum distance metric. At block 820, method 800 determines the blur value associated with scale space image determined in block 818.

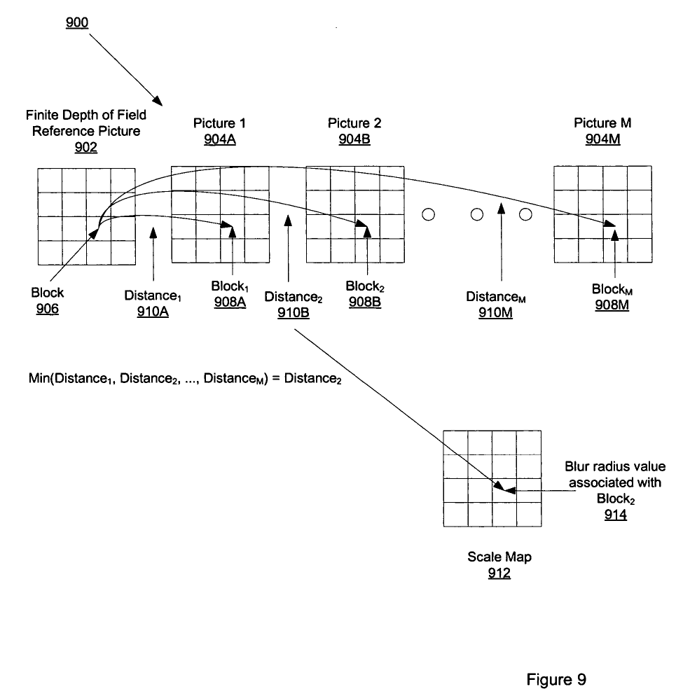

FIG. 9 illustrates one embodiment of selecting the blur value associated with each picture block. Specifically, FIG. 9 illustrates method 800 calculating a set of distances 910A-M between the reference block 906 from the finite depth of field reference picture 902 and a set of blocks 908A-M from the 2D scale space pictures 904A-M. The set of distances 910A-M calculated correspond to processing blocks 810-814 from FIG. 8. Returning to FIG. 9, method 800 determines the minimum distance from the set of distance. As shown by example in FIG. 9, distance₂ 910B is the smallest distance. This means that block₂ 908B is the closest match to reference block 906. Method 800 retrieves the blur value associated with block₂ 908B and copies the value into the appropriate location (block₂ 914) in the picture scale map 912.

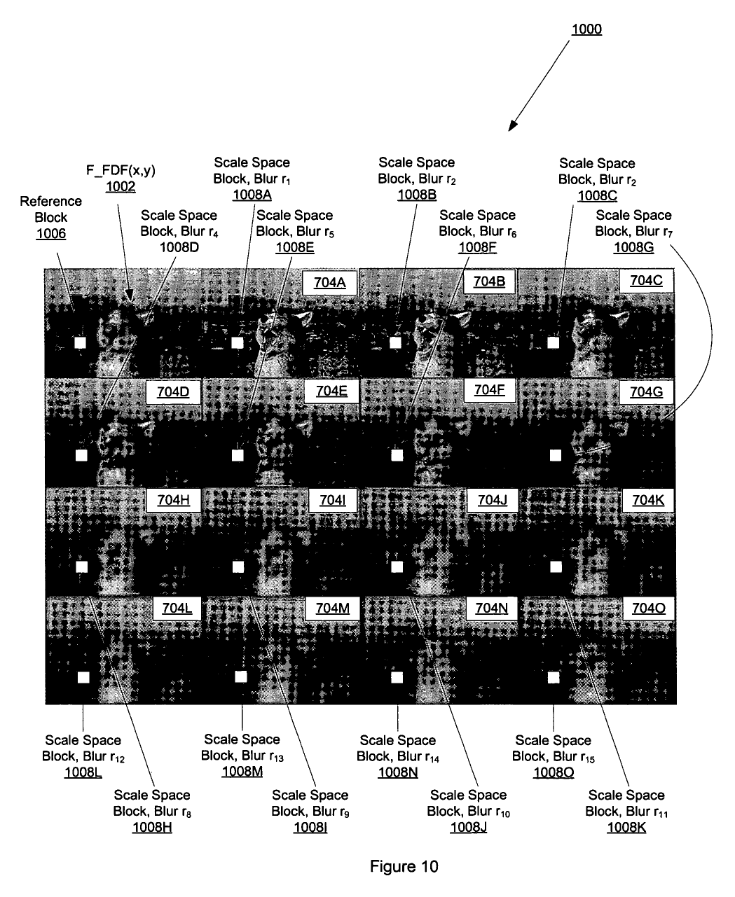

FIG. 10 illustrates using the scale space representation to find a block for the picture scale map according to one embodiment. In FIG. 10, sixteen pictures are illustrated: the finite-depth-of-field picture F_FDF(x,y) 1002 and fifteen pictures 704A-O representing the 2D scale space. As in FIG. 7, the fifteen pictures 704A-O of the 2D scale space in FIG. 10 demonstrates a progressive blurring to the image. Each picture 704A-O of the 2D scale space has an associated known blur radius, r, because each picture 704A-O is created by a quantitative blurring of the all-in-focus reference picture. Matching a block 1006 from F_FDF(x,y) 1002 to one of the similarly located blocks 1008A-O in the 2D scale space pictures allows method 800 to determine the blur radius of the reference block. Because the blur radius is related to the distance an object is to the camera lens by the geometric optics model (e.g., Equation 1), the depth map can be derived from the picture scale map. Taking the example illustrated in FIG. 9 and applying it to the pictures in FIG. 10, if distance₂ is the smallest between the reference block 1006 and the set of blocks from the 2D scale space, the portion of F_FDF(x,y) 1002 in reference block 1006 has blur radius r₂. Therefore, the object in the reference block 1006 has the same blur from the camera lens as block 1008B.

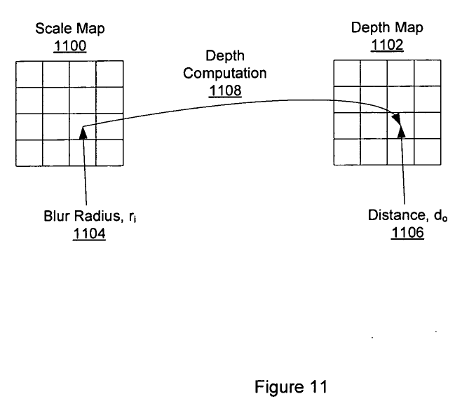

FIG. 11 illustrates one embodiment of calculating the depth map from the picture scale map. In addition, FIG. 11 graphically illustrates the conversion from scale map 912 to depth map 1102 using depth computation 1108. In one embodiment of FIG. 11, method 800 uses Equation 1 for depth computation 1108. Scale map 912 contains N blur radius values with each blur radius value corresponding to the blur radius of an s×s image analysis block of the finite depth of field image, F_FDF(x, y). Method 800 derives the blur radius value for each analysis block as illustrated in FIG. 8, above. In addition, depth map 1102 contains N depth values with each depth value computed from the corresponding blur radius. For example, scale map entry 1104 has blur radius rᵢ which correspond to depth value dᵢ for depth map entry 1106.

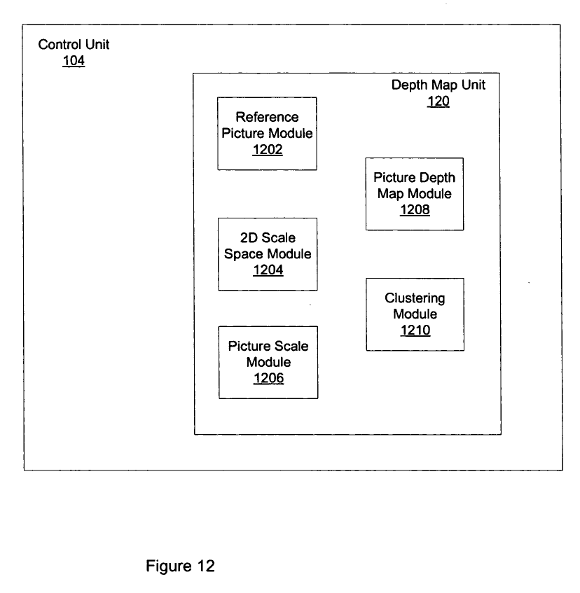

FIG. 12 is a block diagram illustrating one embodiment of an image device control unit that calculates a depth map. In one embodiment, image control unit 104 contains depth map unit 120. Alternatively, image control unit 104 does not contain depth map unit 120, but is coupled to depth map unit 120. Depth map unit 120 comprises reference picture module 1202, 2D scale space module 1204, picture scale module 1206, picture depth map module 1208 and clustering module 1210. Reference picture module 1202 computes the all-in-focus reference picture from a series of images as illustrated in FIG. 2, block 202 and FIGS. 3-5. 2D scale space module 1204 creates the 2D scale space representation of the all-in-focus pictures as illustrated in FIG. 2, block 204 and FIGS. 6-7. Picture scale module 1206 derives the scale map from an actual image and the 2D scale space representation as illustrated in FIG. 2, block 206-208 and FIGS. 8-10. In addition, picture depth map module 1208 calculates the depth map from the scale map using the geometric optics model (Equation 1) as illustrated in FIG. 2, block 210 and FIG. 11. Finally, clustering module 1210 applies a clustering algorithm to the depth map to extract regions containing similar depths and to isolate depth map regions corresponding to outliers and singularities. Referring to FIG. 2, clustering module 1210 performs the function contained in block 212.

In practice, the methods described herein may constitute one or more programs made up of machine-executable instructions. Describing the method with reference to the flowchart in FIGS. 2, 3 and 8 enables one skilled in the art to develop such programs, including such instructions to carry out the operations (acts) represented by logical blocks on suitably configured machines (the processor of the machine executing the instructions from machine-readable media). The machine-executable instructions may be written in a computer programming language or may be embodied in firmware logic or in hardware circuitry. If written in a programming language conforming to a recognized standard, such instructions can be executed on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, process, application, module, logic . . . ), as taking an action or causing a result. Such expressions are merely a shorthand way of saying that execution of the software by a machine causes the processor of the machine to perform an action or produce a result. It will be further appreciated that more or fewer processes may be incorporated into the methods illustrated in the flow diagrams without departing from the scope of the invention and that no particular order is implied by the arrangement of blocks shown and described herein.

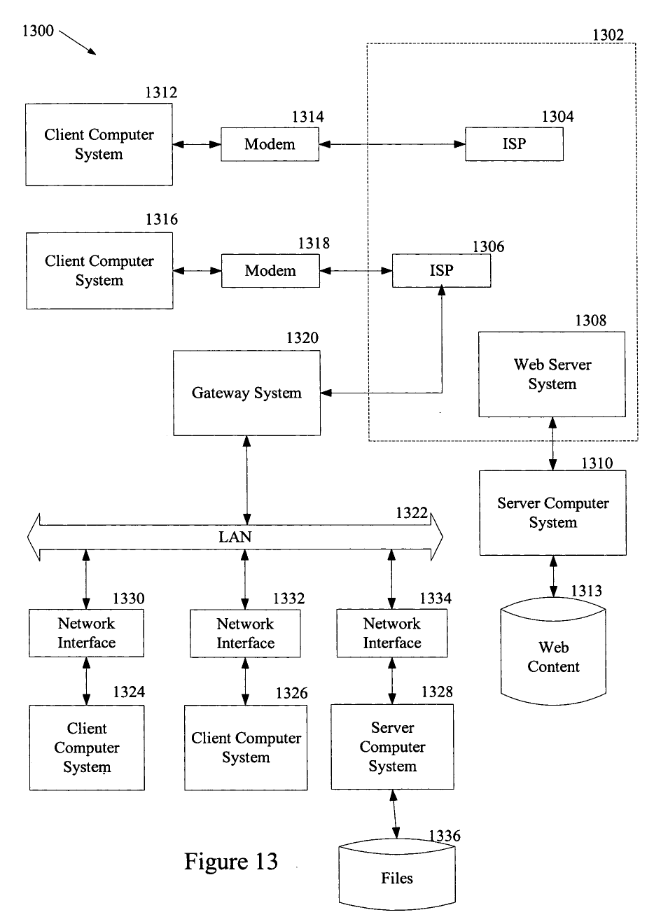

FIG. 13 shows several computer systems 1300 that are coupled together through a network 1302, such as the Internet. The term “Internet” as used herein refers to a network of networks which uses certain protocols, such as the TCP/IP protocol, and possibly other protocols such as the hypertext transfer protocol (HTTP) for hypertext markup language (HTML) documents that make up the World Wide Web (web). The physical connections of the Internet and the protocols and communication procedures of the Internet are well known to those of skill in the art. Access to the Internet 1302 is typically provided by Internet service providers (ISP), such as the ISPs 1304 and 1306. Users on client systems, such as client computer systems 1312, 1316, 1324, and 1326 obtain access to the Internet through the Internet service providers, such as ISPs 1304 and 1306. Access to the Internet allows users of the client computer systems to exchange information, receive and send e-mails, and view documents, such as documents which have been prepared in the HTML format. These documents are often provided by web servers, such as web server 1308 which is considered to be “on” the Internet. Often these web servers are provided by the ISPs, such as ISP 1304, although a computer system can be set up and connected to the Internet without that system being also an ISP as is well known in the art.

The web server 1308 is typically at least one computer system which operates as a server computer system and is configured to operate with the protocols of the World Wide Web and is coupled to the Internet. Optionally, the web server 1308 can be part of an ISP which provides access to the Internet for client systems. The web server 1308 is shown coupled to the server computer system 1310 which itself is coupled to web content 1312, which can be considered a form of a media database. It will be appreciated that while two computer systems 1308 and 1310 are shown in FIG. 13, the web server system 1308 and the server computer system 1310 can be one computer system having different software components providing the web server functionality and the server functionality provided by the server computer system 1310 which will be described further below.

Client computer systems 1312, 1316, 1324, and 1326 can each, with the appropriate web browsing software, view HTML pages provided by the web server 1308. The ISP 1304 provides Internet connectivity to the client computer system 1312 through the modem interface 1314 which can be considered part of the client computer system 1312. The client computer system can be a personal computer system, a network computer, a Web TV system, a handheld device, or other such computer system. Similarly, the ISP 1306 provides Internet connectivity for client systems 1316, 1324, and 1326, although as shown in FIG. 13, the connections are not the same for these three computer systems. Client computer system 1316 is coupled through a modem interface 1318 while client computer systems 1324 and 1326 are part of a LAN. While FIG. 13 shows the interfaces 1314 and 1318 as generically as a “modem,” it will be appreciated that each of these interfaces can be an analog modem, ISDN modem, cable modem, satellite transmission interface, or other interfaces for coupling a computer system to other computer systems. Client computer systems 1324 and 1316 are coupled to a LAN 1322 through network interfaces 1330 and 1332, which can be Ethernet network or other network interfaces. The LAN 1322 is also coupled to a gateway computer system 1320 which can provide firewall and other Internet related services for the local area network. This gateway computer system 1320 is coupled to the ISP 1306 to provide Internet connectivity to the client computer systems 1324 and 1326. The gateway computer system 1320 can be a conventional server computer system. Also, the web server system 1308 can be a conventional server computer system.

Alternatively, as well-known, a server computer system 1328 can be directly coupled to the LAN 1322 through a network interface 1334 to provide files 1336 and other services to the clients 1324, 1326, without the need to connect to the Internet through the gateway system 1320. Furthermore, any combination of client systems 1312, 1316, 1324, 1326 may be connected together in a peer-to-peer network using LAN 1322, Internet 1302 or a combination as a communications medium. Generally, a peer-to-peer network distributes data across a network of multiple machines for storage and retrieval without the use of a central server or servers. Thus, each peer network node may incorporate the functions of both the client and the server described above.

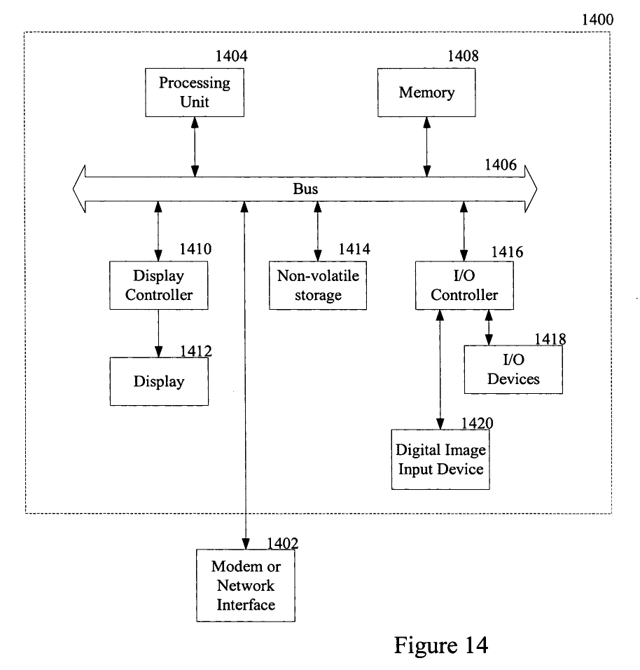

The following description of FIG. 14 is intended to provide an overview of computer hardware and other operating components suitable for performing the methods of the invention described above, but is not intended to limit the applicable environments. One of skill in the art will immediately appreciate that the embodiments of the invention can be practiced with other computer system configurations, including set-top boxes, hand-held devices, multiprocessor systems, microprocessor-based or programmable consumer electronics, network PCs, minicomputers, mainframe computers, and the like. The embodiments of the invention can also be practiced in distributed computing environments where tasks are performed by remote processing devices that are linked through a communications network, such as peer-to-peer network infrastructure.

FIG. 14 shows one example of a conventional computer system that can be used as encoder or a decoder. The computer system 1400 interfaces to external systems through the modem or network interface 1402. It will be appreciated that the modem or network interface 1402 can be considered to be part of the computer system 1400. This interface 1402 can be an analog modem, ISDN modem, cable modem, token ring interface, satellite transmission interface, or other interfaces for coupling a computer system to other computer systems. The computer system 1402 includes a processing unit 1404, which can be a conventional microprocessor such as an Intel Pentium microprocessor or Motorola Power PC microprocessor. Memory 1408 is coupled to the processor 1404 by a bus 1406. Memory 1408 can be dynamic random access memory (DRAM) and can also include static RAM (SRAM). The bus 1406 couples the processor 1404 to the memory 1408 and also to non-volatile storage 1414 and to display controller 1410 and to the input/output (I/O) controller 1416. The display controller 1410 controls in the conventional manner a display on a display device 1412 which can be a cathode ray tube (CRT) or liquid crystal display (LCD). The input/output devices 1418 can include a keyboard, disk drives, printers, a scanner, and other input and output devices, including a mouse or other pointing device. The display controller 1410 and the I/O controller 1416 can be implemented with conventional well known technology. A digital image input device 1420 can be a digital camera which is coupled to an I/O controller 1416 in order to allow images from the digital camera to be input into the computer system 1400. The non-volatile storage 1414 is often a magnetic hard disk, an optical disk, or another form of storage for large amounts of data. Some of this data is often written, by a direct memory access process, into memory 1408 during execution of software in the computer system 1400. One of skill in the art will immediately recognize that the terms “computer-readable medium” and “machine-readable medium” include any type of storage device that is accessible by the processor 1404 and also encompass a carrier wave that encodes a data signal.

Network computers are another type of computer system that can be used with the embodiments of the present invention. Network computers do not usually include a hard disk or other mass storage, and the executable programs are loaded from a network connection into the memory 1408 for execution by the processor 1404. A Web TV system, which is known in the art, is also considered to be a computer system according to the embodiments of the present invention, but it may lack some of the features shown in FIG. 14, such as certain input or output devices. A typical computer system will usually include at least a processor, memory, and a bus coupling the memory to the processor.

It will be appreciated that the computer system 1400 is one example of many possible computer systems, which have different architectures. For example, personal computers based on an Intel microprocessor often have multiple buses, one of which can be an input/output (I/O) bus for the peripherals and one that directly connects the processor 1404 and the memory 1408 (often referred to as a memory bus). The buses are connected together through bridge components that perform any necessary translation due to differing bus protocols.

It will also be appreciated that the computer system 1400 is controlled by operating system software, which includes a file management system, such as a disk operating system, which is part of the operating system software. One example of an operating system software with its associated file management system software is the family of operating systems known as Windows® from Microsoft Corporation of Redmond, Wash., and their associated file management systems. The file management system is typically stored in the non-volatile storage 1414 and causes the processor 1404 to execute the various acts required by the operating system to input and output data and to store data in memory, including storing files on the non-volatile storage 1414.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A computerized method comprising:
generating a two-dimensional scale space representation from an all-in-focus reference picture of a three dimensional spatial scene; and
computing a picture depth map based on the two-dimensional scale space representation and a finite depth of field picture of the three dimensional spatial scene, wherein an entry in the picture depth map has a corresponding entry in a picture scale map.

2. The computerized method of claim 1, further comprising generating the all-in-focus reference picture, wherein generating the all-in-focus reference picture comprises:
capturing a plurality of pictures of the three dimensional spatial scene, wherein a plurality of objects of the three dimensional spatial scene are in focus in at least one picture from the plurality of pictures;
determining a sharpest block from each block group in the plurality of pictures; and
copying the sharpest block from each block group into the all-in-focus reference pictures.

3. The computerized method of claim 1, wherein the generating the picture scale map comprises:
matching each block in the finite depth of field picture to a closest corresponding block in the two-dimensional scale space representation; and
copying the blur value associated with the closest corresponding block into the corresponding entry of the picture scale map.

4. The computerized method of claim 1, wherein the generating the two-dimensional scale space representation comprises applying a family of parametric convolving kernels to the all-in-focus reference picture.

5. The computerized method of claim 4, wherein the family of parametric convolving kernels is selected from the group consisting of a gaussian and a pillbox.

6. The computerized method of claim 1, wherein the two-dimensional scale space representation is a sequence of progressively blurred pictures of the all-in-focus reference picture.

7. The computerized method of claim 6, wherein each picture in the sequence of progressively blurred pictures has a known blur value.

8. The method of claim 1, further comprising:
applying a clustering algorithm to the depth map.

9. The computerized method of claim 1, wherein the computing the picture depth map comprises:
generating the picture scale map entry from the finite depth of field picture and the two-dimensional scale space representation; and
calculating, from the picture scale map entry, the picture depth map entry using the equation
$${d}_{o} = \frac{fD}{D - f - 2 {rf}_{number}} ,$$
where f is the camera lens focal length, D the distance between the image plane inside the camera and the lens, r is the blur radius of the image on the image plane and f number is the f_{number} of the camera lens.

10. A machine readable medium having executable instructions to cause a processor to perform a method comprising:
generating a two-dimensional scale space representation from an all-in-focus reference picture of a three dimensional spatial scene; and
computing a picture depth map based on the two-dimensional scale space representation and a finite depth of field picture of the three dimensional spatial scene, wherein an entry in the picture depth map has a corresponding entry in a picture scale map.

11. The machine readable medium of claim 10, further comprising generating the all-in-focus reference picture, wherein generating the all-in-focus reference picture comprises:
capturing a plurality of pictures of the three dimensional spatial scene, wherein a plurality of objects of the three dimensional spatial scene are in focus in at least one picture from the plurality of pictures;
determining a sharpest block from each block group in the plurality of pictures; and
copying the sharpest block from each block group into the all-in-focus reference pictures.

12. The machine readable medium of claim 10, wherein the generating the picture scale map comprises:
matching each block in the finite depth of field picture to a closest corresponding block in the two-dimensional scale space representation; and
copying the blur value associated with the closest corresponding block into the corresponding entry of the picture scale map.

13. The machine readable medium of claim 10, wherein the generating the two-dimensional scale space representation comprises applying a family of parametric convolving kernels to the all-in-focus reference picture.

14. The machine readable medium of claim 10 wherein the computing the picture depth map comprises:
generating a picture scale map from the finite depth of field picture and the two-dimensional scale space representation; and
calculating, from a picture scale map entry, the picture depth map entry using the equation
$${d}_{o} = \frac{fD}{D - f - 2 {rf}_{number}} ,$$
where f is the camera lens focal length, D the distance between the image plane inside the camera and the lens, r is the blur radius of the image on the image plane and f number is the f_{number} of the camera lens.

15. An apparatus comprising:
means for generating a two-dimensional scale space representation from an all-in-focus reference picture of a three dimensional spatial scene; and
means for computing a picture depth map based on the two-dimensional scale space representation and a finite depth of field picture of the three dimensional spatial scene, wherein an entry in the picture depth map has a corresponding entry in a picture scale map.

16. The apparatus of claim 15, further comprising means for generating the all-in-focus reference picture, wherein the means for generating the all-in-focus reference picture comprises:
means for capturing a plurality of pictures of the three dimensional spatial scene, wherein a plurality of objects of the three dimensional spatial scene are in focus in at least one picture from the plurality of pictures;
means for determining a sharpest block from each block group in the plurality of pictures; and
means for copying the sharpest block from each block group into the all-in-focus reference pictures.

17. A system comprising:
a processor;
a memory coupled to the processor though a bus; and
a process executed from the memory by the processor to cause the processor to generate a two-dimensional scale space representation from an all-in-focus reference picture of a three dimensional spatial scene and to compute a picture depth map based on the two-dimensional scale space representation and a finite depth of field picture of the three dimensional spatial scene, wherein an entry in the picture depth map has a corresponding entry in a picture scale map.

18. The system of claim 17, wherein the process further causes the processor to generate the all-in-focus reference picture, the all-in-focus reference picture generation comprises:
capturing a plurality of pictures of the three dimensional spatial scene, wherein a plurality of objects of the three dimensional spatial scene are in focus in at least one picture from the plurality of pictures;
determining a sharpest block from each block group in the plurality of pictures; and
copying the sharpest block from each block group into the all-in-focus reference pictures.

19. The system of claim 17, wherein the generating the picture scale map comprises:
matching each block in the finite depth of field picture to a closest corresponding block in the two-dimensional scale space representation; and
copying the blur value associated with the closest corresponding block into the corresponding entry of the picture scale map.

20. The system of claim 17, wherein the generating the two-dimensional scale space representation comprises applying a family of parametric convolving kernels to the all-in-focus reference picture.
